(19) United States
(12) Patent Application Publication
(10) Pub. No.: US 2006/0200534 A1
(43) Pub. Date: Sep. 7, 2006

(54) Multi-medium information sharing system

(76) Inventors: Takahiro Nagai, Osaka-shi (JP); Shinji Sasaki, Osaka-shi (JP); Yoshiki Kuno, Osaka-shi (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 10/553,385

(22) PCT Filed: Apr. 23, 2004
(86) PCT No.: PCT/JP04/05958

§ 371 Date: Oct. 19, 2005

(30) Foreign Application Priority Data
Apr. 25, 2003 (JP) 2003-121870

(51) Int. Cl. G06F 15/167

(52) U.S. Cl. 709/212

(57) ABSTRACT

In a multimedia information sharing system, multimedia information is shared between multiple devices over a network to which a server is connected. The server includes: a management table for managing identifiers to identify terminal devices and the addresses of the devices on the network; a server receiving section receiving the identifier from a first terminal device; a processing section for getting the address of the first terminal device by reference to the identifier received and the address of a second terminal device, identified by another identifier received, by reference to the identifier and the management table; and a server transmitting section for sending the address of the second terminal device to the first terminal device if the first terminal device retains the multimedia information and sending the address of the first terminal device to the second terminal device if the second terminal device retains the multimedia information. The multimedia information is transmitted, received and shared between the first and second terminal devices by reference to the address provided.

### TECHNICAL FIELD

The present invention relates to the technique of sharing and exchanging multimedia information, such as moving pictures, still pictures, music and so on that are stored in a terminal device, with other terminal devices over a network.

### BACKGROUND ART

Recently, as various types of digital recording equipment has become increasingly popular, an individual home user has more and more opportunities to create massive multimedia information concerning video and/or audio including moving pictures, still pictures, music and so on. In the prior art, the creator of multimedia information sends an email with the multimedia information attached from his or her own terminal device or makes the multimedia information public at his or her own website or a provider's website so that his or her relatives and friends can browse it. To own the same piece of multimedia information at multiple terminal devices or make that piece of information browsable at multiple terminal devices will be referred to herein as “sharing” the multimedia information.

If that massive multimedia information such as moving pictures or music is shared often by such a method, then the load on a mail server or web server may become too heavy. Thus, providers will need bigger server systems. In that case, however, the cost of maintaining such a bigger server system will eventually have to be paid for by its users. That is to say, the users will have to pay higher fees for that purpose. To overcome such problems, a multimedia information distribution system and a file swap system for sharing such multimedia information and swapping massive files directly between the terminals by the peer-to-peer technique have just been developed.

FIG. 8 shows a configuration for a conventional massive multimedia information distribution system 61. Japanese Patent Application Laid-Open Publication No. 11-88419 discloses an example of such a massive multimedia information distribution system. In this multimedia information distribution system 61, a terminal device 64 as a client requests information for accessing multimedia information (such as moving picture titles) from a search server 63S over the Worldwide Web (WWW) that is configured as a network 62. As used herein, the “title” refers to a complete playback unit such as a single musical tune, a still picture, or a movie as a combination of moving picture and music.

In response to the request, the search server 63S searches title information 67 stored in respective multimedia servers 63A, 63B and 63C on a server list 65. As used herein, the “title information” refers to information showing correspondence between a title and its properties. For example, the “title information” includes the name of the title and the encoding type, the attribute (e.g., moving picture, still picture or music) of the title identified by that name, or search information.

As a result of the search, the search server 63S acquires a search result including link information for establishing a link to the multimedia servers 63A to 63C that stores the moving picture titles. Furthermore, the search server 63S gets a page of a website 66 for transmissive access displayed on the screen of the client's terminal device 64 and distributes the search result to the client through the transmissive access website 66.

By using the link information included in the search result, the terminal device 64 receives desired multimedia information directly from one of the multimedia servers 63 that store the multimedia information. Specifically, the multimedia information is transmitted as a multimedia file 68 from the multimedia server 63 and received at the terminal device 64. In this manner, the multimedia information that is stored in multiple sources of multimedia information can be easily searched and the transmitted information can be received. Also, if the terminal device 64 does not have a multimedia viewer for reading a multimedia file, the multimedia viewer can also be downloaded from the multimedia server 63.

Meanwhile, file swap systems such as “Napster” have been used recently. For example, an article entitled “Without knowing Napster”, Nikkei Electronics No. 780, published on Oct. 9, 2000, pp. 125-145 describes a file swap system that uses “Napster”. In this file swap system, a user cannot acquire his or her desired multimedia information until he or she submits a request by himself or herself. More specifically, a user of the file swap system connects his or her own client terminal to a search server in advance and enters a title list, including the titles of multimedia information stored in his or her own client terminal, into the search server. Then, the user searches other users' title lists that have also been entered into the search server, thereby determining whether or not his or her desired title is included. If the desired title has been found, the user connects his or her client terminal to a client terminal that stores the multimedia information with that title and swaps a multimedia file with the desired title between the client terminals. That is why in this file swap system, a client terminal that stores multimedia information does not transmit the multimedia information to another client terminal until the former client terminal receives a request from the latter client terminal.

In the conventional multimedia information distribution systems and file swap systems, a terminal device can acquire multimedia information that is stored in another particular terminal device or in a multimedia server by submitting a request by itself. However, the former terminal device cannot transmit the multimedia information stored in itself to the latter terminal device. That is to say, the terminal device on the transmitting end cannot share multimedia information on its own initiative with the terminal device on the receiving end.

Also, if such a system is composed of digital consumer electronic appliances such as hard disk recorders or DVD recorders, then a digital consumer electronic appliance on the receiving end may be unable to play back the multimedia information received. This is because a network, to which digital consumer electronic appliances of various generations or produced by various manufacturers are connected, may include a digital consumer electronic appliance that cannot process multimedia information according to its format, for example. Unlike a general-purpose personal computer (PC), a digital consumer electronic appliance has its resources (such as hardware) fixed when shipped as a product. That is why it is difficult to newly add a function of decoding the multimedia information to such an appliance. Under the circumstances such as these, the technique of processing only multimedia information to be played back by every appliance on the receiving end needs to be developed.

Thus, an object of the present invention is to get multimedia information shared between a terminal device on a transmitting end, which owns and can transmit the multimedia information, and a terminal device on the receiving end in response to the request of the device on the transmitting end.

### DISCLOSURE OF INVENTION

A server according to the present invention is used in a system that is designed to transmit, receive and share multimedia information between a plurality of terminal devices that are connected together over a network. The server includes: a management table for managing identifiers to identify the terminal devices and the addresses of the terminal devices on the network; a server receiving section, which receives the identifier from a first one of the terminal devices; a processing section for getting the address of the first terminal device on the transmitting end based on reception of the identifier and also getting the address of a second one of the terminal devices, identified by the identifier received, by reference to the identifier and the management table; and a server transmitting section for sending the address of the second terminal device to the first terminal device when the first terminal device retains the multimedia information and for sending the address of the first terminal device to the second terminal device when the second terminal device retains the multimedia information. As a result, the multimedia information is transmitted, received and shared between the first and second terminal devices by reference to the address provided.

In the case where the first terminal device retains the multimedia information, the server receiving section may receive the identifier of the second terminal device and a share request to share the multimedia information from the first terminal device, and the server transmitting section may send the share request to the second terminal device. When the server receiving section receives an acknowledgement, indicating that the multimedia information is receivable, from the second terminal device in response to the share request, the server transmitting section may send the address of the second terminal device and a request to transmit the multimedia information to the first terminal device.

The first terminal device may have a transmitting-end database on which the multimedia information, including at least one title, and title information, representing the properties of the at least one title, are stored. The server receiving section may receive the title information, stored in the transmitting-end database, from the first terminal device. The processing section may make a title list, including predetermined titles, based on the title information and the identifier of the second terminal device. The server transmitting section may transmit the title list to the first terminal device and may receive a request to share the multimedia information, selected by reference to the title list, from the first terminal device.

The processing section may make a tilt list including titles that are playable by the second terminal device.

In the case where the first terminal device retains the multimedia information, the server may further include a format description table that describes correspondence between the identifiers to identify the terminal devices and the formats of the multimedia information that are compatible with the respective devices. The processing section may generate filter information about the format compatible with the second terminal device by reference to the format description table. The server transmitting section may transmit the filter information to the first terminal device. A request to share the multimedia information that has been filtered by the first terminal device in accordance with the filter information may be sent from the first terminal device to the second terminal device, whereby the multimedia information may be transmitted, received and shared between the first and second terminal devices.

In the case where the second terminal device retains the multimedia information, the server receiving section may receive the identifier of the second terminal device and a share request to share the multimedia information from the first terminal device. The server transmitting section may send the share request and the address of the first terminal device to the second terminal device. When the server receiving section receives an acknowledgement, indicating that the multimedia information is transmittable, from the second terminal device in response to the share request, the server transmitting section may transmit a request to receive the multimedia information to the first terminal device.

The second terminal device may have a transmitting-end database on which the multimedia information, including at least one title, and title information, representing the properties of the at least one title, are stored. The server receiving section may receive the title information, stored in the transmitting-end database, from the second terminal device. The processing section may make a title list, including predetermined titles, based on the title information and the identifier of the first terminal device. The server transmitting section may transmit the title list to the first terminal device and may receive a request to share the multimedia information, selected by reference to the title list, from the first terminal device.

The processing section may make a tilt list including titles that are playable by the first terminal device.

The address may include an IP address and a port number.

The server may further include a search section for searching the title information that is stored in the transmitting-end database. The server receiving section may receive the title information based on a result of the search done by the search section.

A processing method according to the present invention is carried out by a server for use in a system that is designed to transmit, receive and share multimedia information between a plurality of terminal devices that are connected together over a network. The server includes a management table for managing identifiers to identify the terminal devices and the addresses of the terminal devices on the network. The method includes the steps of: receiving the identifier from a first one of the terminal devices; getting the address of the first terminal device on the transmitting end based on reception of the identifier received and also getting the address of a second one of the terminal devices, identified by the identifier received, by reference to the identifier and the management table; and sending the address of the second terminal device to the first terminal device when the first terminal device retains the multimedia information and sending the address of the first terminal device to the second terminal device when the second terminal device retains the multimedia information. As a result, the multimedia information is transmitted, received and shared between the first and second terminal devices by reference to the address provided.

In the case where the first terminal device retains the multimedia information, the step of receiving may include receiving the identifier of the second terminal device and a share request to share the multimedia information from the first terminal device. The step of sending may include sending the share request to the second terminal device. When an acknowledgement, indicating that the multimedia information is receivable, is received from the second terminal device in response to the share request, the step of sending may include sending the address of the second terminal device and a request to transmit the multimedia information to the first terminal device.

The first terminal device may have a transmitting-end database on which the multimedia information, including at least one title, and title information, representing the properties of the at least one title, are stored. The step of receiving may include receiving the title information, stored in the transmitting-end database, from the first terminal device. The step of processing may include making a title list, including predetermined titles, based on the title information and the identifier of the second terminal device. When in the step of sending, the title list is sent to the first terminal device after that, the step of receiving may include receiving a request to share the multimedia information, selected by reference to the title list, from the first terminal device.

The step of processing may include making a tilt list including titles that are playable by the second terminal device.

In the case where the first terminal device retains the multimedia information, the server may further include a format description table that describes correspondence between the identifiers to identify the terminal devices and the formats of the multimedia information that are compatible with the respective devices. The step of processing may include generating filter information about the format compatible with the second terminal device by reference to the format description table. The step of sending may include transmitting the filter information to the first terminal device. As a result, a request to share the multimedia information that has been filtered by the first terminal device in accordance with the filter information may be sent from the first terminal device to the second terminal device, and the multimedia information may be transmitted, received and shared between the first and second terminal devices.

In the case where the second terminal device retains the multimedia information, the step of receiving may include receiving the identifier of the second terminal device and a share request to share the multimedia information from the first terminal device. The step of sending may include sending the share request and the address of the first terminal device to the second terminal device. When an acknowledgement, indicating that the multimedia information is transmittable, is received from the second terminal device in response to the share request, the step of sending may include sending a request to receive the multimedia information to the first terminal device.

The second terminal device may have a transmitting-end database on which the multimedia information, including at least one title, and title information, representing the properties of the at least one title, are stored. The step of receiving may include receiving the title information, stored in the transmitting-end database, from the second terminal device. The step of processing may include making a title list, including predetermined titles, based on the title information and the identifier of the first terminal device. When in the step of sending, the title list is sent to the first terminal device after that, the step of receiving may include receiving a request to share the multimedia information, selected by reference to the title list, from the first terminal device.

The step of processing may include making a tilt list including titles that are playable by the first terminal device.

The address may include an IP address and a port number.

The method may further include the step of searching the title information that is stored in the transmitting-end database. In that case, the step of receiving may include receiving the title information based on a result of the step of searching.

A terminal device on the transmitting end according to the present invention is used in a system, which is designed to transmit, receive and share multimedia information between a plurality of terminal devices that are connected together over a network, to transmit the multimedia information.

A first terminal device on the transmitting end may include: a transmitting-end database on which the multimedia information is stored; a memory for retaining the identifier of a terminal device on the receiving end, to which the multimedia information is transmitted; a transmitting section for transmitting the identifier of the terminal device on the receiving end to a server that is connected to the network; and a receiving section for receiving the address of the terminal device on the receiving end from the server. The transmitting section transmits the multimedia information to the address of the terminal device on the receiving end. The server includes a management table for managing identifiers to identify the terminal devices and the addresses of the terminal devices on the network, and finds the address of the terminal device on the receiving end by reference to the management table and the identifier of the terminal device on the receiving end.

A second terminal device on the transmitting end may include: a transmitting-end database on which the multimedia information is stored; a receiving section for receiving a request to transmit the multimedia information; and a transmitting section for transmitting the multimedia information in response to the request to transmit. When the receiving section receives the address of a terminal device on the receiving end, the transmitting section transmits the multimedia information to the address of the terminal device on the receiving end. The terminal device on the receiving end retains the identifier to identify the terminal device on the transmitting end. The server includes a management table for managing identifiers to identify the terminal devices and the addresses of the terminal devices on the network. When the terminal device on the receiving end transmits the identifier to the server, the server finds the address of the terminal device on the transmitting end by reference to the management table and the identifier. The terminal device on the receiving end or the server transmits the transmit request to the address of the terminal device on the transmitting end.

A terminal device on the receiving end according to the present invention is used in a system, which is designed to transmit, receive and share multimedia information between a plurality of terminal devices that are connected together over a network, to receive the multimedia information that has been sent from a terminal device on the transmitting end.

A first terminal device on the receiving end may include: a transmitting section for transmitting its own address on the network and an identifier to identify itself to a server that is connected to the network; and a receiving section for receiving the multimedia information from a terminal device on the transmitting end. The terminal device on the transmitting end may store the identifier in advance, may receive the address of the terminal device on the receiving end from the server by transmitting the identifier to the server, and may transmit the multimedia information to the address of the terminal device on the receiving end. The server may include a management table for managing identifiers to identify the terminal devices and the addresses of the terminal devices on the network, may find the address of the terminal device on the receiving end by reference to the management table and the identifier of the terminal device on the receiving end, and may send it to the terminal device on the transmitting end.

A second terminal device on the receiving end may include: a memory for storing an identifier to identify the terminal device on the transmitting end; a transmitting section for transmitting its own address on the network, an identifier to identify itself and the identifier of the terminal device on the transmitting end to a server that is connected to the network; and a receiving section for receiving the multimedia information from the terminal device on the transmitting end. The terminal device on the transmitting end may include a transmitting-end database on which the multimedia information is stored. The server may find the address of the terminal device on the transmitting end by reference to the management table and the identifier of the terminal device on the transmitting end. When the transmitting section sends a request to transmit the multimedia information, the request is sent to the specified address of the terminal device on the transmitting end. In response to the transmit request, the terminal device on the transmitting end transmits the multimedia information to the terminal device on the receiving end. The address of the terminal device on the receiving end is transmitted from either the server or the terminal device on the receiving end.

According to the present invention, when a request to share multimedia information is submitted by a terminal device on the receiving end, a connection management server makes a new title list by extracting information about titles that are playable by the terminal device on the receiving end, and transmits it to a terminal device on the transmitting end that stores the multimedia information. The user of the terminal device on the transmitting end can select multimedia information about a desired one of the titles that are playable by the terminal device on the receiving end and are designated by the title list. Thus, the user does not have to pay attention to the compatible formats of the terminal device on the receiving end. As a result, the multimedia information can be shared by the terminal devices on the receiving and transmitting ends just as intended.

### BRIEF DESCRIPTION OF DRAWINGS

FIG. 1 schematically shows a configuration for a multimedia information sharing system.

FIG. 2 is a block diagram showing an exemplary basic hardware configuration for terminal devices on receiving and transmitting ends.

FIG. 3 shows respective arrangements of functional blocks for a connection management server and two terminal devices.

FIG. 4 shows the flow of a pull-type multimedia information sharing process in which multimedia information is transmitted from a terminal device on the transmitting end to a terminal device on the receiving end in response to a request from the terminal device on the receiving end.

FIG. 5 shows the flow of a push-type multimedia information sharing process in which multimedia information is transmitted from a terminal device on the transmitting end to a terminal device on the receiving end in response to a request from the terminal device on the transmitting end.

FIG. 6 shows the flow of another pull-type multimedia information sharing; process according to a preferred embodiment of the present invention.

FIG. 7 shows the flow of another push-type multimedia information sharing process according to a preferred embodiment of the present invention.

FIG. 8 shows a configuration for a conventional massive multimedia information distribution system.

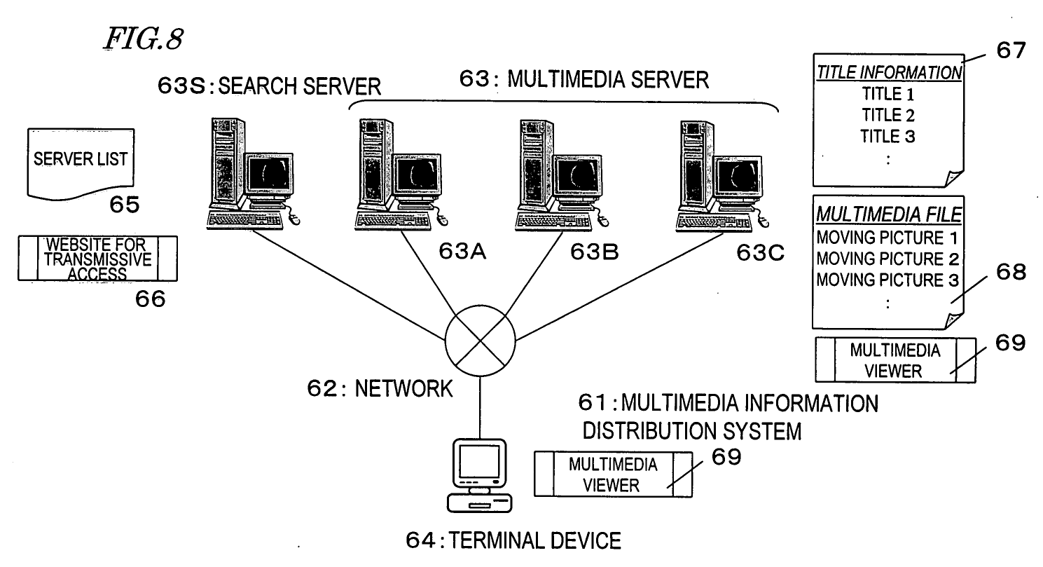

### BEST MODE FOR CARRYING OUT THE INVENTION

Hereinafter, preferred embodiments of a multimedia information sharing system according to the present invention will be described with reference to the accompanying drawings.

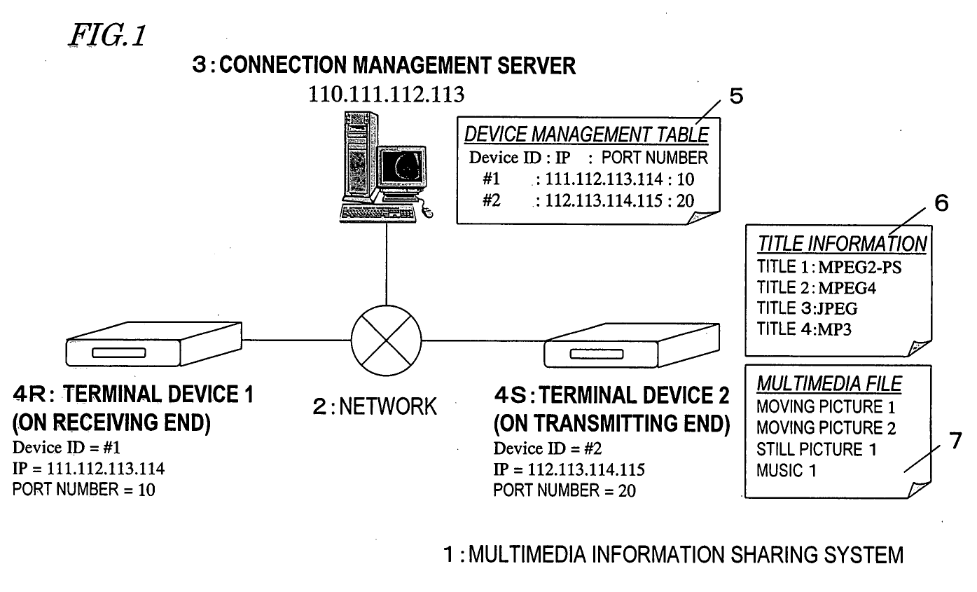

FIG. 1 schematically shows a configuration for a multimedia information sharing system 1. In this multimedia information sharing system 1, when a request to share a piece of multimedia information is submitted by a certain terminal device, another terminal device, storing that multimedia information, transmits the multimedia information to the designated terminal device. As a result, the multimedia information can be shared between the terminal devices on the transmitting and receiving ends. In the following description, a terminal device that retains and transmits multimedia information will be referred to herein as a “terminal device on the transmitting end”, while a terminal device that receives the multimedia information will be referred to herein as a “terminal device on the receiving end”. In this multimedia information sharing system 1, the terminal device on the transmitting end can submit a share request by itself as will be described later, and the multimedia information can be shared between the terminal devices on the transmitting and receiving ends.

The multimedia information sharing system 1 includes a connection management server 3, a terminal device 4S on the transmitting end, and a terminal device 4R on the receiving end, which are all connected to a network 2. In this preferred embodiment, the network 2 may be either a wide area network (WAN) such as the Internet or a local area network (LAN) within a company, for example. Communications are exchanged so as to comply with the TCP/IP protocol, for example, among the connection management server 3 and terminal devices 4S and 4R. Optionally, three or more terminal devices may be connected to the network 2.

The connection management server 3 manages the IP addresses and port numbers of the terminal devices 4R and 4S that can share the multimedia information. The connection management server 3 has also been given an IP address, which is an address that identifies the connection management server 3 in the network 2. The connection management server 3 can receive a share request that has been submitted by either the terminal device 4R or the terminal device 4S to the IP address of the connection management server 3. In the meantime, information that designates the terminal device on the receiving end, with which the multimedia information will be shared, is also transmitted. In response to the share request received, title information 6 about the multimedia information in the terminal device 4S on the transmitting end is also acquired from the terminal device 4S on the transmitting end.

The connection management server 3 manages a set of title information, which is stored in the terminal device 4S on the transmitting end, as a title list. Depending on whether or not the terminal device 4R on the receiving end can play the titles, the connection management server 3 filters the title list, thereby extracting a title list that includes only titles that are playable by the terminal device 4R on the receiving end. The result of the filtering operation is returned to the terminal device that has submitted the share request.

By reference to the title list that has been narrowed by the filtering result received from the connection management server 3, the user of the terminal device 4R or 4S that has submitted the share request selects titles to be shared between the terminal devices 4R and 4S. The connection management server 3 mediates the request to share the multimedia information. That is to say, the connection management server 3 submits a transmit request that instructs the terminal device 4S on the transmitting end to transmit the multimedia information, and also submits a receive request that instructs the terminal device 4R on the receiving end to receive the multimedia information transmitted. As a result, the multimedia information selected is directly exchanged between the terminal devices 4S and 4R on the transmitting and receiving ends. Also, as shown in FIG. 1, the multimedia information is transmitted, received and stored as a multimedia file 7 described in a predetermined format.

Each of the terminal devices 4R and 4S has a Device ID, which is a unique identifier given to each terminal device, and an IP address, which is its own address showing its location on the network 2. The IP address may be a static global IP address that is always fixed, a dynamic global IP address that is allocated dynamically by the DHCP server of an Internet service provider, or a local IP address within a router, which has been allocated by the router if the terminal device is connected to the network 2 by way of the router having a DHCP function. Each terminal device further has a port number that designates a communication application.

In this preferred embodiment, the connection management server 3 has an IP address “110.111.112.113”, the terminal device 4R on the receiving end has an IP address “111.112.113.114”, a Device ID “#1” and a port number “10”, and the terminal device 4S on the transmitting end has an IP address “112.113.114.115”, a Device ID “#2” and a port number “20” as shown in FIG. 1.

When connected to the network 2 successfully, the terminal devices 4S and 4R provide their own information for the connection management server 3. As used herein, “their own information” includes the Device ID, IP address and port number of the terminal device that has transmitted the packet and is described in an address providing packet. The address providing packet is transmitted to the IP address “110.111.112.113” of the connection management server 3.

The connection management server 3 acquires the Device ID, IP address and port number of each terminal device from the address providing packet received, and lists them on a device management table 5. If a terminal device is connected to the network 2 by way of a router having the DHCP function, the terminal device has been given a local IP address. However, the global IP address that has been given to the router due to a well known IP masquerade function of the router and the port number allocated by the router are transmitted as the IP address and port number of the terminal device to the connection management server 3. In response, the connection management server 3 lists the global IP address and port number in association with the Device ID of the terminal device.

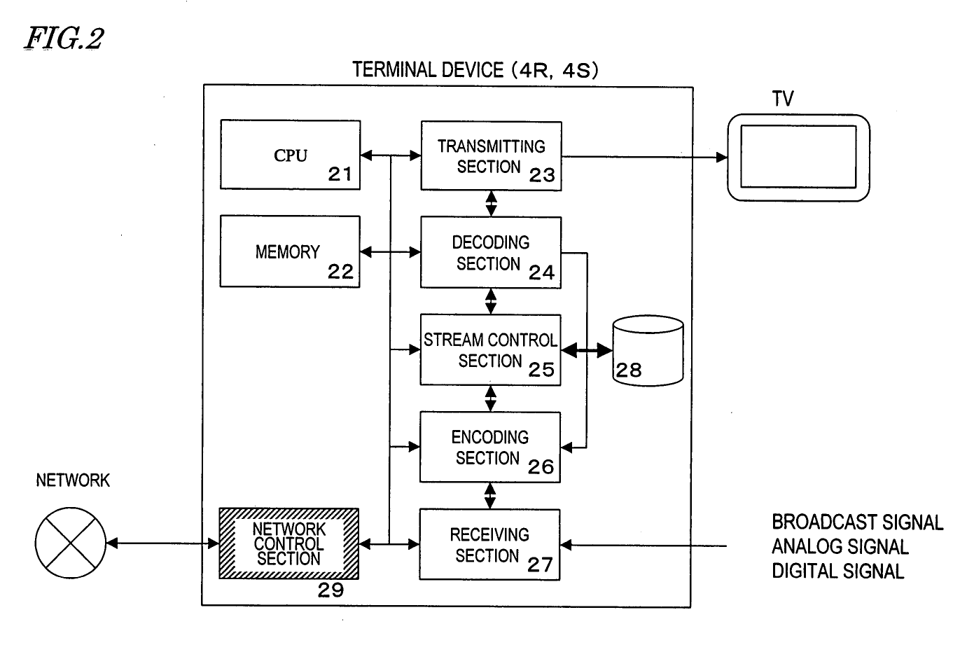

FIG. 2 is a block diagram showing an exemplary basic hardware configuration for the terminal devices 4R, 4S on the receiving and transmitting ends. The terminal device 4R, 4S may be a digital consumer electronic appliance, which has a network connecting function and which can record and play multimedia information, such as a hard disk recorder or a DVD recorder.

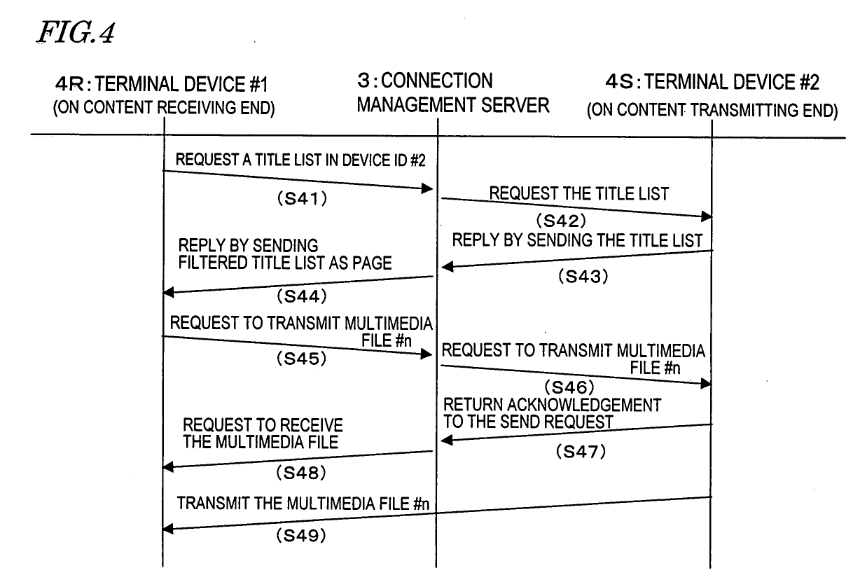

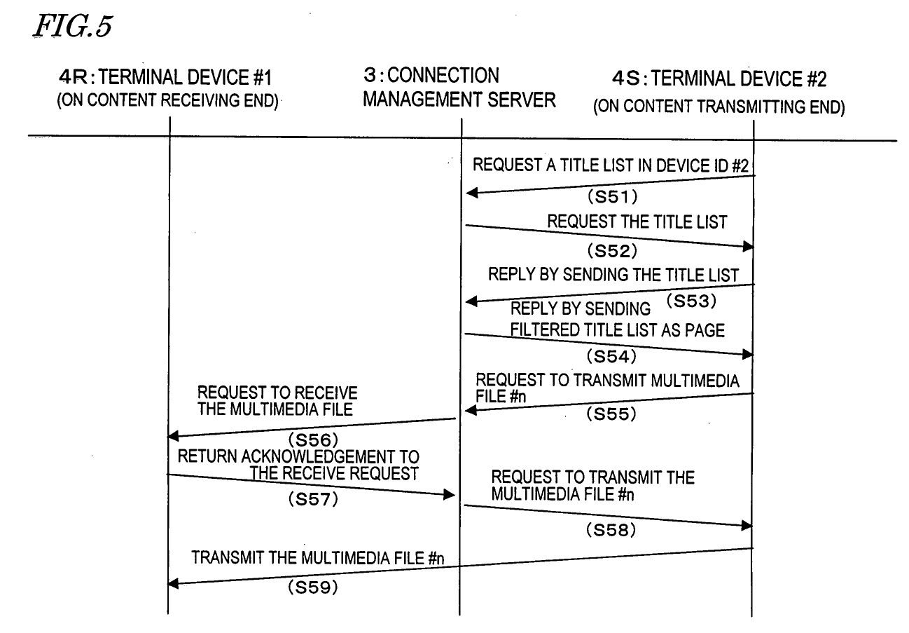

The terminal device includes a CPU 21, a memory 22, a transmitting section 23, a decoding section 24, a stream control section 25, an encoding section 26, a receiving section 27, a storage device 28, and a network control section 29. These components may be connected together with a bus such as a CPU bus or a data bus. The CPU 21 controls the operation of the terminal device. Specific contents of the control operation carried out by the CPU 21 will be described later as to the processing done by the multimedia information sharing system 1 shown in FIGS. 4 and 5. The memory 22 may be a semiconductor memory device that stores programs, data and so on. The transmitting section 23 transmits a multimedia signal such as video and/or audio to an external device like a TV set.

The decoding section 24 expands the multimedia information that has been compressed by a predetermined compression method such as an MPEG standard. By getting the multimedia information expanded by the decoding section 24 and transmitted to a TV set, a stereo, etc., moving pictures, still pictures or audio can be played as multimedia information. Accordingly, the decoding section 24 forms a part of the playback means of the terminal device. The compression method that the decoding section 24 adopts for expansion purposes differs from one terminal device to another. Generally speaking, it is often difficult to provide an additional multimedia information decoding function for the decoding section 24 of a digital consumer electronic appliance. This is because the resources such as hardware are fixed when such a product is shipped.

The storage device 28 is a drive for storing multimedia information on a hard disk, a DVD or any other storage medium. The stream control section 25 controls the operation of the storage device or the data transfer of the multimedia information. The encoding section 26 compresses and encodes the video, audio and other data by a compression method such as an MPEG standard. As to this encoding section 26, the compression method also differs from one terminal device to another. The receiving section 27 receives a signal including multimedia information from an external device. As used herein, the “signal including multimedia information” may be a broadcast signal received from a TV station or an analog signal and/or a digital signal received from another device.

The network control section 29 connects the terminal device to the network 2 and transmits and receives data in compliance with the TCP/IP protocol. Even during a timer recording operation, the network control section 29 is always supplied with electrical power and is ready to send an address providing packet to the server. Furthermore, the network control section 29 can receive various requests and data from the network 2. The network control section 29 is designed to turn the overall terminal device ON and start to process a request to search a title list, a request to transmit multimedia information, or a request to receive multimedia information on receiving it from the connection management server 3.

The terminal device has a browser function of presenting multimedia information on a TV monitor based on the data of a multimedia file that has been received via the network control section 29. In the example illustrated in FIG. 1, the terminal device is supposed to be a hard disk recorder. However, the terminal device may also be implemented as a normal computer with a network connection function. The functions of the respective components described above and the overall terminal device are realized not only by hardware but also by software.

The multimedia information sharing system 1 of this preferred embodiment is designed so as to cope with a situation where digital consumer electronic appliances of various generations, produced by different manufacturers, are connected together as the terminal devices. The decoding section 24 has a different decoding function on one terminal device to another as described above. That is why some terminal device may be unable to decode multimedia information received. However, the multimedia information sharing system 1 of this preferred embodiment handles only multimedia information that can be shared between the terminal devices on the receiving and transmitting ends by carrying out a process to be described later. As a result, the user can avoid such confusion.

The connection management server 3 may be implemented as a normal computer with a network connection function. The connection management server 3 may be formed by the CPU 21, memory 22, stream control section 25, storage device 28, and network control section 29, among the components of the terminal device shown in FIG. 2. In the connection management server 3, a database function realizing the device management table to be described later and the function of filtering the title list to extract only the multimedia information that can be shared between the terminal devices on the receiving and transmitting ends are realized by software. Such software is read out from the storage device 28 onto the memory 22 and then carried out by the CPU 21.

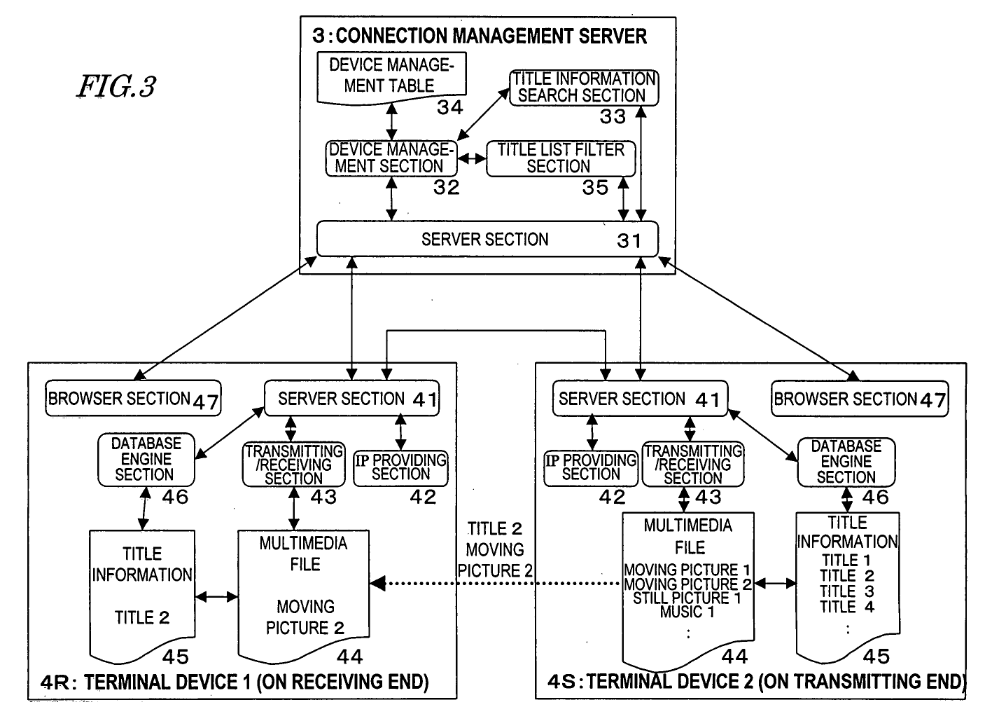

Hereinafter, the respective functions of the connection management server 3 and terminal devices 4R and 4S will be described with reference to FIG. 3, which shows respective arrangements of functional blocks for the connection management server 3 and terminal devices 4R and 4S. In the example illustrated in FIG. 3, the terminal device 1 (4R) on the receiving end and the terminal device 2 (4S) on the transmitting end are each implemented as a terminal device having the functions of transmitting and receiving multimedia information.

The terminal device 4R, 4S includes a server section 41, an IP providing section 42, a transmitting/receiving section 43, a multimedia information database 44, a title information database 45, a database engine section 46, and a browser section 47.

The server section 41 transfers information to another terminal device or connection management server over the network 2. Examples of the transferred information include multimedia information, title information, and a request to share the multimedia information.

The IP providing section 42 transmits an address providing packet, including the Device ID, IP address and port number of the terminal device, to the connection management server 3. The transmitting/receiving section 43 transmits and receives the multimedia information to/from another terminal device. The multimedia information database 44 is a database for storing and saving the multimedia information. The title information database 45 is a database that collects title information. The database engine section 46 controls the title information database 45 and exchanges data with the server section 41. The browser section 47 presents information about titles that can be shared between the terminal devices 4S and 4R on the transmitting and receiving ends.

On the other hand, the connection management server 3 includes a server section 31, a device management section 32, a title information search section 33 and a title list filter section 35.

The server section 31 transfers data to a terminal device over the network. When receiving data, the server section 31 gets the address of the terminal device that has transmitted the data.

The device management section 32 analyzes the address providing packet that has been received from a terminal device and lists the Device ID, IP address and port number of the terminal device, included in the packet, on the device management table 34. When receiving another address providing packet from a registered terminal device and being notified that the address of the terminal device has been changed, the device management section 32 also updates the address on the device management table 34. Furthermore, if a terminal device has sent out no address providing packets for a certain period of time or more, then the device management section 32 deletes the address entry of the terminal device from the device management table 34. When another component requests the address of a terminal device, the device management section 32 searches the device management table 34 for the address. If that address has been found, then the device management section 32 provides that address.

The title information search section 33 operates on receiving a request for a title list from a terminal device. The request for a title list is a request to send a list of titles of multimedia information that has been stored in the terminal device on the transmitting end. This request can be submitted by both the terminal device on the receiving end and the terminal device on the transmitting end. The title information search section 33 asks the device management section 32 for the address, thereby getting the address of the terminal device on the transmitting end that is listed on the device management table 34. And the title information search section 33 requests the terminal device on the transmitting end at that address to search the title information. Then, the title information search section 33 receives the search result.

The title list filter section 35 acquires the search result of the title information, which has been received from the terminal device 4S on the transmitting end, as a title list, and filters the title list to extract only the title information of titles that are playable by the terminal device on the receiving end, thereby making a new title list. This filtering operation may be carried out by reference to a compatible format description table that describes correspondence between the Device ID of the terminal device on the receiving end and the format of its playable multimedia information. The following Table 1 shows an exemplary compatible format description table.

TABLE 1
Compatible format description table

| Device ID | Compatible format |
|---|---|
| #1 | MPEG2-PS |
| | MPEG4 |
| #2 | MPEG2-PS |
| | MPEG2-TS/SD |
| | MPEG2-TS/HD |
| | MPEG4 |

On receiving a Device ID from a terminal device on the receiving end, for example, the title list filter section 35 asks the terminal device on the receiving end for its compatible format and compiles a compatible format description table according to the type of the compatible format replied. Or if the Device ID, listed on the device management table 34, includes information about the product type (or product model) of each terminal device, then the title list filter section 35 may find the compatible format for the terminal device on the receiving end according to the Device ID and may compile a compatible format description table. The table compiled in this manner is stored in a memory or a buffer (not shown).

Hereinafter, it will be described in detail how the title list filter section 35 performs its processing using the compatible format description table shown as Table 1. Suppose the title list filter section 35 has got the title information of four different moving picture programs from the terminal device on the transmitting end (with Device ID #2). Those pieces of title information got by the title list filter section 35 will be identified by (Content 1, MPEG2-PS), (Content 2, MPEG2-TS/SD), (Content 3, MPEG2-TS/HD) and (Content 4, MPEG4). A title list is obtained by compiling these pieces of title information. In this case, the formats of moving pictures that are playable by the terminal device on the receiving end (with Device ID #1) are supposed to be MPEG2-PS and MPEG4.

By reference to the compatible format description table, the title list filter section 35 knows that the formats of moving pictures that are playable by the terminal device on the receiving end (with Device ID #1) are MPEG2-PS and MPEG4. Thus, the title list filter section 35 extracts (Content 1, MPEG2-PS) and (Content 4, MPEG4) from the title list, thereby making a new title list. The title list filter section's function of extracting a title list by reference to the compatible format description table will be referred to herein as a “title list filtering function”.

The title list filter section 35 transmits the title list, obtained as a result of the filtering, to the terminal device that has requested the title list. As to the other formats including a moving picture format (such as WMV), music formats (such as MP3, WMA, AAC and ATRAC) and still picture formats (such as JPEG and GIF), a compatible format description table, describing correspondence between the Device ID of the terminal device on the receiving end and the formats of playable multimedia information, may be compiled similarly. As a result, the title list filtering function described above can also be realized. If the terminal device on the receiving end is compatible with every format of the multimedia information stored in the terminal device on the transmitting end, then the title list remains the same before and after the filtering.

Hereinafter, the format conversion processing will be described by way of specific examples. First, suppose the title information of four moving picture programs, including (Content 1, MPEG2-PS), (Content 2, MPEG2-TS/SD), (Content 3, MPEG2-TS/HD) and (Content 4, MPEG4), is described on the title list of moving picture programs that the title list filter section 35 has got from the terminal device 4S on the transmitting end. The formats of moving pictures that are playable by the terminal device 4R on the receiving end are supposed to be MPEG2-PS and MPEG4. That is to say, the terminal device 4R on the receiving end is not compatible with MPEG2-TS. On the other hand, the terminal device 4S on the transmitting end can do a format conversion from MPEG2-TS into MPEG2-PS.

The title list filter section 35 extracts the title information of formats, which are compatible without doing any format conversion, from the title list. That is to say, the title list filter section 35 extracts (Content 1, MPEG2-PS) and (Content 4, MPEG4). After that, the title list filter section 35 determines whether or not the format MPEG2-TS, which has been regarded as non-compatible, can be converted by the terminal device on the transmitting end. Since the terminal device 4S on the transmitting end can do a format conversion, the formats of Contents 2 and 3 may be converted into MPEG2-PS, in which the title information may be described. That is to say, (Content 2, MPEG2-PS) and (Content 3, MPEG2-PS) are obtained. This series of processing is the filtering function of the title list filter section 35 when the format conversion is needed.

As a result of the filtering done by the title list filter section 35, a title list, including (Content 1, MPEG2-PS), (Content 2, MPEG2-PS), (Content 3, MPEG2-PS) and (Content 4, MPEG4), is made. The title list filter section 35 transmits this result to the terminal device that has requested the title list. In this example, a format conversion from MPEG2-TS into MPEG2-PS has been described. As to the other formats including a moving picture format (such as WMV), music formats (such as MP3, WMA, AAC and ATRAC) and still picture formats (such as JPEG and GIF), filtering may also be carried out in a similar manner by reference to the title list of the terminal device on the transmitting end and the compatible formats and convertible formats of the terminal device on the receiving end.

Also, if the generations or manufacturers of the terminal devices are different from each other, then the terminal devices may comply with mutually different communication protocols. In that case, the server section 31 searches the title list in compliance with the respective communication protocols to share the multimedia information.

Hereinafter, it will be described with reference to FIGS. 4 and 5 how the multimedia information sharing system 1 of the present invention operates. FIGS. 4 and 5 each shows the processing done by the terminal device 4R on the receiving end, terminal device 4S on the transmitting end, and connection management server 3 time-sequentially. Specifically, FIG. 4 shows the flow of a pull-type multimedia information sharing process in which multimedia information is transmitted from the terminal device 4S on the transmitting end to the terminal device 4R on the receiving end in response to a request from the terminal device 4R on the receiving end. FIG. 5 shows the flow of a push-type multimedia information sharing process in which multimedia information is transmitted from the terminal device 4R on the transmitting end to the terminal device 4R on the receiving end in response to a request from the terminal device 4S on the transmitting end. The direction in which three lines extend from the terminal device 4R on the receiving end, connection management server 3 and terminal device 4S on the transmitting end is the positive direction on the time axis.

First, the pull-type multimedia information sharing process will be described with reference to FIG. 4. In Step S41, the terminal device 4R on the receiving end requests a list of titles that can be shared between the terminal device 4S on the transmitting end (with Device ID #2) and the terminal device 4R on the receiving end (with Device ID #1) from the connection management server 3 with a particular address. By reference to the received Device ID #2 of the terminal device 4S on the transmitting end, the connection management server 3 searches the device management table 34 for the IP address and port number of the terminal device 4S on the transmitting end. In Step S42, the connection management server 3 requests a list of titles that are stored in the terminal device 4S on the transmitting end from the terminal device on the transmitting end by using the IP address and port number that have been obtained as a result of the search.

In response, the terminal device 4S on the transmitting end sends the title list of multimedia information, stored as the title information, to the connection management server 3 in Step S43. Then, the connection management server 3 filters the title list received, thereby extracting information about titles that are playable by the terminal device 4R on the receiving, end (with Device ID #1) and making a new title list. Subsequently, in Step S44, the connection management server 3 returns a new title list filtered as web page data in HTML format, which can be displayed by the browser of the terminal device 4R on the receiving end, to the terminal device 4R on the receiving end. Then, the user selects a desired title from the title list displayed through the browser.

Next, in Step S45, the terminal device 4R on the receiving end sends a request to share the multimedia information that has been selected by the user to the connection management server 3. In Step S46, in response to the request to share the multimedia information from the terminal device 4R on the receiving end, the connection management server 3 sends a request to transmit the multimedia file that has been selected by the user to the terminal device 4S on the transmitting end. In this processing step, the address of the terminal device 4R on the receiving end, to which the multimedia file will have to be transmitted, is also sent to the terminal device 4S on the transmitting end. In Step S47, the terminal device 4S on the transmitting end receives the request to transmit the multimedia file and returns an acknowledgement of the transmit request to the connection management server 3 if the multimedia file requested can be transferred. Next, in Step S48, the connection management server 3 receives the acknowledgement from the terminal device 4S on the transmitting end and then sends a request to receive the multimedia file to the terminal device on the receiving end.

Thereafter, in Step S49, the multimedia file selected is directly transferred from the terminal device 4S on the transmitting end to the terminal device 4R on the receiving end. In Step S47, if the terminal device 4S on the transmitting end cannot transfer the multimedia file requested in response to the received request to transmit the multimedia file, then the terminal device 4S on the transmitting end returns a denial of the transmit request to the connection management server 3. The multimedia file cannot be transferred if sufficient resources (e.g., the hard disk) are not available as the terminal on the transmitting end is recording or playing, or if the terminal device on the transmitting, end has already begun transmitting or receiving a multimedia file to/from another terminal device. In that case, the transmission gets on hold by making the transmit request reserved. The transmit request and the address of the terminal device 4R on the receiving end, to which the file will be transferred, will be sent again either in a predetermined amount of time after the request got on hold or at a specified point in time, thereby attempting to transfer the multimedia file.

Hereinafter, the push type multimedia information sharing processing will be described with reference to FIG. 5. In Step S51, the terminal device 4S on the transmitting end requests a title list of the terminal device 4S on the transmitting end from the connection management server 3. Such a request is transmitted because the terminal device 4S on the transmitting end of this preferred embodiment is designed not to transmit the title list to the connection management server 3 until the connection management server 3 requests it. Thus, by requesting its own title list from the connection management server 3, the terminal device 4S on the transmitting end can receive a title list request from the connection management server 3. As already described with reference to FIG. 4, the connection management server 3 has the function of requesting a title list from the terminal device that has been identified by the Device ID. That is why the connection management server 3 needs no special transmitting/receiving functions to carry out the process shown in FIG. 5.

By reference to the received Device ID #2 of the terminal device 4S on the transmitting end, the connection management server 3 searches the device management table 34 for the IP address and port number of the terminal device 4S on the transmitting end. Then, in Step S52, the connection management server 3 requests a list of titles stored from the terminal device 4S on the transmitting end by using the IP address and port number.

In response to the title list request, the terminal device 4S on the transmitting end sends the title list stored as the title information to the connection management server 3 in Step S53. In this processing step, the terminal device 4S on the transmitting end also transmits the Device ID #1 of the terminal device 4R on the receiving end. This is because the connection management server 3 needs the Device ID of the terminal device 4R on the receiving end in order to extract a list of titles that are playable by the terminal device 4R on the receiving end through the filtering operation. That is why the user of the terminal device 4S on the transmitting end needs to get the Device ID #1 of the terminal device 4R on the receiving end from its user and store it in the memory 22 or storage device 28 of the terminal device 4S on the transmitting end.

Then, the connection management server 3 extracts a list of titles that are playable by the terminal device 4R on the receiving end from the received title list through the filtering operation. Subsequently, in Step S54, the connection management server 3 returns a data file in HTML format, which can be displayed by the browser of the terminal device 4S on the transmitting end, to the terminal device 4S on the transmitting end. The terminal device 4S on the transmitting end just needs to transmit the Device ID of the terminal device 4R on the receiving end to the connection management server 3 before the filtering operation is carried out. The connection management server 3 refers to the device management table 34 with the Device ID of the terminal device 4R on the receiving end, thereby finding the address of the terminal device 4R on the receiving end.

When the contents of the data file are displayed by the browser, the user selects a desired title from a list of titles that are playable by the terminal on the receiving end and that are now presented by the browser. Next, in Step S55, the terminal device 4S on the transmitting end sends a request to share the multimedia information that has been selected by the user to the connection management server 3. Then, in Step S56, in response to the request to share the multimedia information from the terminal device 4S on the transmitting end, the connection management server 3 sends a request to receive the multimedia file that has been selected by the user to the terminal device 4R on the receiving end. The terminal device 4R on the receiving end receives the request to receive the multimedia file.

If the terminal device 4R on the receiving end can receive the multimedia file that the terminal device has been instructed to receive, then the terminal device 4R on the receiving end returns an acknowledgement of the receive request to the connection management server 3 in Step S57. When receiving the acknowledgement from the terminal device on the receiving end, the connection management server 3 sends a request to transmit the multimedia file to the terminal device 4S on the transmitting end in Step S58. In this processing step, the connection management server 3 also notifies the terminal device 4S on the transmitting end of the address of the terminal device 4R on the receiving end. Then, in Step S59, the terminal device 4S on the transmitting end directly transfers the selected multimedia file to the terminal device 4R on the receiving end, to which the specified address has been given.

If the terminal device 4R on the receiving end cannot receive the multimedia file that the terminal device has been instructed to receive, then the terminal device 4R on the receiving end returns a denial of the receive request to the connection management server 3 in Step S57. The multimedia file cannot be received if sufficient resources (e.g., the hard disk) are not available as the terminal on the receiving end is recording or playing or if the terminal device on the receiving end has already begun transmitting or receiving a multimedia file to/from another terminal device. In that case, the connection management server 3 gets the reception on hold by making the receive request reserved. The connection management server 3 will send again the receive request either in a predetermined amount of time after the request got on hold or at a specified point in time.

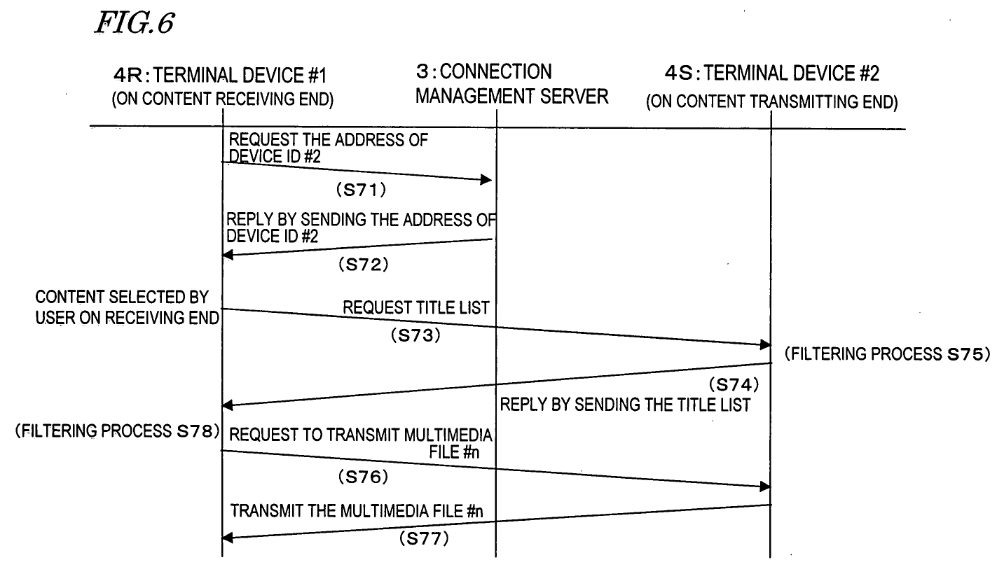

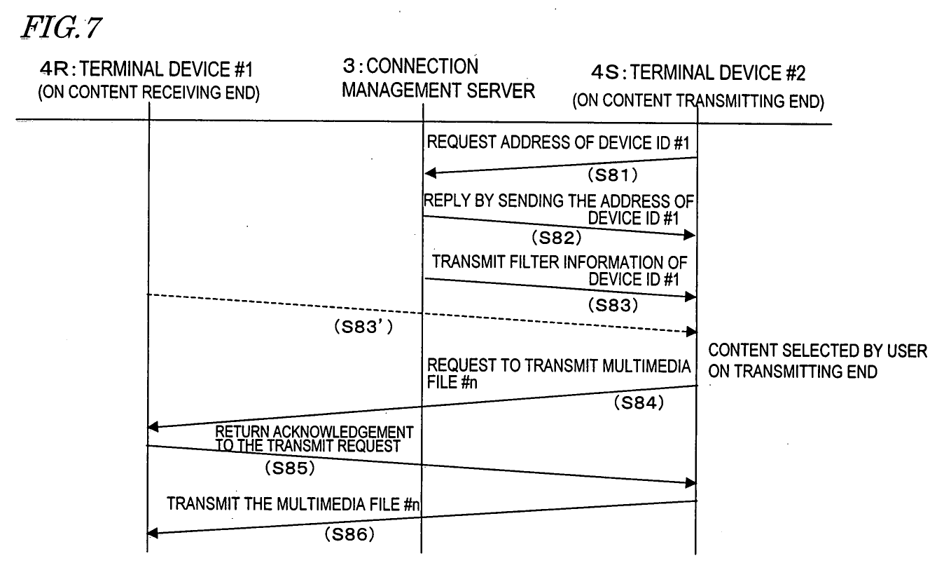

In the preferred embodiment described above, the title list filter section 35 is provided for the connection management server 3. Alternatively, the title list filter section 35 may also be provided for either the terminal device 4S on the transmitting end or the terminal device 4R on the receiving end. FIGS. 6 and 7 show the flows of processing in which multimedia information is shared by making the terminal device 4S on the transmitting end or terminal device 4R on the receiving end filter the title list. This filtering function is realized by the CPU 21 of the terminal device 4S on the transmitting end or that of the terminal device 4R on the receiving end, and is equivalent to the filtering function that the title list filter section 35 of the connection management server 3 has. Hereinafter, the respective processes shown in FIGS. 6 and 7 will be described.

FIG. 6 shows the flow of another pull-type multimedia information sharing process according to this preferred embodiment. First, in Step S71, the terminal device 4R on the receiving end requests the address of the terminal device 4S on the transmitting end (with a Device ID #2) from the connection management server 3. By reference to the information identifying the terminal device 4S on the transmitting end (i.e., Device ID #2), the connection management server 3 searches the device management table 34 for the IP address and port number of the terminal device 4S on the transmitting end. In Step S72, the connection management server 3 transmits the IP address and port number, which have been found as a result of the search, to the terminal device 4R on the receiving end.

In Step S73, the terminal device 4R on the receiving end requests the list of titles, which are stored in the terminal device 4S on the transmitting end, from the terminal device 4S on the transmitting end by reference to the IP address and port number received. Along with this request, the terminal device 4R on the receiving end also transmits filter information to the terminal device 4S on the transmitting end. As used herein, the “filter information” is information about formats that are compatible with the terminal device 4R on the receiving end (with a Device ID #1). In this preferred embodiment, the compatible formats are MPEG2-PS and MPEG4.

In Step S75, the terminal device 4S on the transmitting end filters the title list of the multimedia information, which is stored as the title information, in accordance with the filter information. Then, in Step S74, the terminal device 4S on the transmitting end transmits the title list filtered to the terminal device 4R on the receiving end. This title list includes only titles, of which the formats are compatible with the terminal device 4R on the receiving end. It should be noted that as the terminal device 4S on the transmitting end has been requested by the terminal device 4R on the receiving end to send a title list to the terminal device 4R, the terminal device 4S on the transmitting end already knows the address of the terminal device 4R on the receiving end. Thus, the terminal device 4S on the transmitting end can transmit the title list filtered to the terminal device 4R on the receiving end.

In Step S76, the terminal device 4R on the receiving end sends a request to share the multimedia information that has been selected by the user to the terminal device 4S on the transmitting end. In response to this request, the terminal device 4R on the receiving end transmits the designated multimedia file to the terminal device 4R on the receiving end in Step S77. When the terminal device 4R on the receiving end receives this file, the processing ends.

In the processing described above, the terminal device 4S on the transmitting end filters the title list. However, the title list may also be filtered by the terminal device 4R on the receiving end instead. In that case, the terminal device 4R on the receiving end may receive a title list, containing all titles, from the terminal device 4S on the transmitting end and may filter the title list in accordance with its own filter information stored. This processing step may be carried out in place of the processing step S75 described above. FIG. 6 shows the alternative filtering process done by the terminal device 4R on the receiving end as a processing step S78.

FIG. 7 shows the flow of another push-type multimedia information sharing process according to this preferred embodiment. First, in Step S81, the terminal device 4S on the transmitting end requests the address of the terminal device 4R on the receiving end (with a Device ID #1) from the connection management server 3. By reference to the information identifying the terminal device 4R on the receiving end (i.e., Device ID #1), the connection management server 3 searches the device management table 34 for the IP address and port number of the terminal device 4R on the receiving end. In Step S82, the connection management server 3 transmits the IP address and port number, which have been found as a result of the search, to the terminal device 4S on the transmitting end. Also, in Step S83, the connection management server 3 transmits the filter information of the terminal device 4R on the receiving end (with a Device ID #1). The “filter information” is just as defined above. By reference to the identifier (Device ID #1) of the terminal device 4R on the receiving end, the connection management server 3 extracts its compatible formats from the compatible format description table (shown as Table 1), thereby generating the filter information.

The terminal device 4S on the transmitting end filters the title list of the multimedia information, which is stored as the title information, in accordance with the filter information. Next, the user of the terminal device 4S on the transmitting end selects a multimedia file to be transmitted to the terminal device 4R on the receiving end by reference to the title list filtered. Then, in Step S84, the terminal device 4S on the transmitting end sends a request to share the multimedia information that has been selected by the user to the terminal device 4R on the receiving end.

In response to this request, the terminal device 4R on the receiving, end returns an acknowledgement of the transmit request to the terminal device 4S on the transmitting end in Step S85. On receiving the acknowledgement, the terminal device 4S on the transmitting end transmits the designated multimedia file to the terminal device 4R on the receiving end in Step S86. When the terminal device 4R on the receiving end receives this file, the processing ends.

In the example described above, the connection management server 3 is supposed to transmit the filter information to the terminal device 4S on the transmitting end in Step S83. Alternatively, the terminal device 4R on the receiving end may directly transmit the filter information to the terminal device 4S on the transmitting end. In that case, the filter information is transmitted as indicated as Step S83′ by the dashed line in FIG. 7. To make the terminal device 4R on the receiving end transmit the filter information, the connection management server 3 may instruct the terminal device 4R on the receiving end to transmit the filter information in the processing step S82, for example.

In the processing shown in FIGS. 6 and 7, when filtering the title list, the terminal device 4S on the transmitting end may convert the format of the multimedia information by reference to the Device ID and filter information of the terminal device 4R on the receiving end. As a result, the terminal device 4R on the receiving end can share more multimedia information with the terminal device 4S on the transmitting end.

In the preferred embodiments described above, both of the terminal devices on the receiving and transmitting ends are supposed to have the address providing function. However, since TCP/IP is used as the communication protocol, the terminal device that submits the title list request in the processing flows shown in FIGS. 4 and 5 (i.e., in the processing steps S41 and S51) does not always have to have the address providing function. This is because in TCP/IP, the IP address and port address are described on the headers of an IP packet and a TCP packet. By using the IP address and port number that are described on the IP packet and TCP packet, the device management section 32 can also get the multimedia information shared even if a title list request has been received from a terminal device with no Device ID or a terminal device with a Device ID that is not listed on the device management table 34. As a result, even a general-purpose PC or a mobile terminal that supports the TCP/IP protocol can also share the multimedia information with a terminal device by way of the connection management server.

Furthermore, in the preferred embodiments described above, the multimedia information stored in a terminal device on the transmitting end is supposed to be searched in response to a title list request that has been sent from a terminal device. However, if the connection management server 3 has a database that includes the title list of the multimedia information stored in the terminal device on the transmitting end, the title list of the multimedia information stored in the terminal on the transmitting end may be entered in advance into the database of the connection management server. Then, the title list can be returned immediately in response to a title list request from the user.

As described above, in the multimedia information sharing system of this preferred embodiment, no matter whether a request to share multimedia information has been submitted by the terminal device 4R on the receiving end or the terminal device 4S on the transmitting end, the terminal devices 4S and 4R on the transmitting and receiving ends can share the multimedia information.

The connection management server 3 extracts a list of titles that are playable by the terminal device on the receiving end by filtering the list of titles stored in the terminal device 4S on the transmitting end. Thus, the user can select his or her desired multimedia information by himself or herself without worrying about its compatibility.

Also, the connection management server 3 manages the Device IDs and IP addresses of the terminal devices. Accordingly, even if the IP address of a terminal device has changed, the terminal device to share the multimedia information with can still be connected to by reference to the Device ID uniquely given to that device. Furthermore, not only the Device IDs and IP addresses of the terminal devices but also their port numbers may be managed as well. In that case, even in a connection environment in which a number of terminal devices are connected to a single router with a global address and are given local IP addresses that are effective only in the router, any particular terminal device can be identified by its connection address, consisting of the global address of the router and the port number given to the terminal device, and can be accessed by another terminal device connected to the Internet by way of the router.

Furthermore, even if the terminal devices connected to the connection management server 3 are of different generations or produced by different manufacturers and comply with mutually different communication protocols, the connection management server 3 may change the communication protocols of the respective terminal devices one by one. Then, the user can share multimedia information without sensing the difference in communication protocol.

### INDUSTRIAL APPLICABILITY

According to the present invention, a data communications system, in which a terminal device storing multimedia information requests a particular terminal device to transmit the multimedia information and then transmits the multimedia information thereto, can be established. That is to say, the multimedia information can be shared between terminal devices on the receiving and transmitting ends at the request of the terminal device on the transmitting end. Consequently, information can be shared in a different manner from the conventional system in which multimedia information is transmitted in response to a request of a terminal device on the receiving end.

1. A server for use in a system that is designed to transmit, receive and share multimedia information between a plurality of terminal devices that are connected together over a network, the server comprising:
a management table for managing identifiers to identify the terminal devices and the addresses of the terminal devices on the network;
a server receiving section, which receives the identifier from a first one of the terminal devices;
a processing section for getting the address of the first terminal device on the transmitting end based on reception of the identifier and also getting the address of a second one of the terminal devices, identified by the identifier received, by reference to the identifier and the management table; and
a server transmitting section for sending the address of the second terminal device to the first terminal device when the first terminal device retains the multimedia information and for sending, the address of the first terminal device to the second terminal device when the second terminal device retains the multimedia information,
wherein the multimedia information is transmitted, received and shared between the first and second terminal devices by reference to the address provided.

2. The server of claim 1, wherein in the case where the first terminal device retains the multimedia information,
the server receiving section receives the identifier of the second terminal device and a share request to share the multimedia information from the first terminal device, and the server transmitting section sends the share request to the second terminal device, and
when the server receiving section receives an acknowledgement, indicating that the multimedia information is receivable, from the second terminal device in response to the share request, the server transmitting section sends the address of the second terminal device and a request to transmit the multimedia information to the first terminal device.

3. The server of claim 2, wherein the first terminal device has a transmitting-end database on which the multimedia information, including at least one title, and title information, representing the properties of the at least one title, are stored, and
wherein the server receiving section receives the title information, stored in the transmitting-end database, from the first terminal device, and
wherein the processing section makes a title list, including predetermined titles, based on the title information and the identifier of the second terminal device, and
wherein the server transmitting section transmits the title list to the first terminal device and receives a request to share the multimedia information, selected by reference to the title list, from the first terminal device.

4. The server of claim 3, wherein the processing section makes a tilt list including titles that are playable by the second terminal device.

5. The server of claim 1, wherein in the case where the first terminal device retains the multimedia information,
the server further includes a format description table that describes correspondence between the identifiers to identify the terminal devices and the formats of the multimedia information that are compatible with the respective devices,
the processing section generates filter information about the format compatible with the second terminal device by reference to the format description table, and the server transmitting section transmits the filter information to the first terminal device, and
a request to share the multimedia information that has been filtered by the first terminal device in accordance with the filter information is sent from the first terminal device to the second terminal device, whereby the multimedia information is transmitted, received and shared between the first and second terminal devices.

6. The server of claim 1, wherein in the case where the second terminal device retains the multimedia information,
the server receiving section receives the identifier of the second terminal device and a share request to share the multimedia information from the first terminal device, and the server transmitting section sends the share request and the address of the first terminal device to the second terminal device, and
when the server receiving section receives an acknowledgement, indicating that the multimedia information is transmittable, from the second terminal device in response to the share request, the server transmitting section sends a request to receive the multimedia information to the first terminal device.

7. The server of claim 6, wherein the second terminal device has a transmitting-end database on which the multimedia information, including at least one title, and title information, representing the properties of the at least one title, are stored, and
wherein the server receiving section receives the title information, stored in the transmitting-end database, from the second terminal device, and
wherein the processing section makes a title list, including predetermined titles, based on the title information and the identifier of the first terminal device, and
wherein the server transmitting section transmits the title list to the first terminal device and receives a request to share the multimedia information, selected by reference to the title list, from the first terminal device.

8. The server of claim 7, wherein the processing section makes a tilt list including titles that are playable by the first terminal device.

9. The server of claim 1, wherein the address includes an IP address and a port number.

10. The server of claim 3, further comprising a search section for searching the title information that is stored in the transmitting-end database,
wherein the server receiving section receives the title information based on a result of the search done by the search section.

11. A method for processing a server for use in a system that is designed to transmit, receive and share multimedia information between a plurality of terminal devices that are connected together over a network, the server including a management table for managing identifiers to identify the terminal devices and the addresses of the terminal devices on the network, the method comprising the steps of:
receiving the identifier from a first one of the terminal devices;
getting the address of the first terminal device on the transmitting end based on reception of the identifier and also getting the address of a second one of the terminal devices, identified by the identifier received, by reference to the identifier and the management table; and
sending the address of the second terminal device to the first terminal device when the first terminal device retains the multimedia information and sending the address of the first terminal device to the second terminal device when the second terminal device retains the multimedia information,
whereby the multimedia information is transmitted, received and shared between the first and second terminal devices by reference to the address provided.

12. The method of claim 11, wherein in the case where the first terminal device retains the multimedia information,
the step of receiving includes receiving the identifier of the second terminal device and a share request to share the multimedia information from the first terminal device,
the step of sending includes sending the share request to the second terminal device, and
when an acknowledgement, indicating that the multimedia information is receivable, is received from the second terminal device in response to the share request, the step of sending includes sending the address of the second terminal device and a request to transmit the multimedia information to the first terminal device.

13. The method of claim 12, wherein the first terminal device has a transmitting-end database on which the multimedia information, including at least one title, and title information, representing the properties of the at least one title, are stored, and
wherein the step of receiving includes receiving the title information, stored in the transmitting-end database, from the first terminal device, and
wherein the step of processing includes making a title list, including predetermined titles, based on the title information and the identifier of the second terminal device, and
wherein when in the step of sending, the title list is sent to the first terminal device after that,
the step of receiving includes receiving a request to share the multimedia information, selected by reference to the title list, from the first terminal device.

14. The method of claim 13, wherein the step of processing includes making a tilt list including titles that are playable by the second terminal device.

15. The method of claim 11, wherein in the case where the first terminal device retains the multimedia information,
the server further includes a format description table that describes correspondence between the identifiers to identify the terminal devices and the formats of the multimedia information that are compatible with the respective devices,
the step of processing includes generating filter information about the format compatible with the second terminal device by reference to the format description table, and
the step of sending includes transmitting the filter information to the first terminal device,
whereby a request to share the multimedia information that has been filtered by the first terminal device in accordance with the filter information is sent from the first terminal device to the second terminal device, and the multimedia information is transmitted, received and shared between the first and second terminal devices.

16. The method of claim 11, wherein in the case where the second terminal device retains the multimedia information,
the step of receiving includes receiving the identifier of the second terminal device and a share request to share the multimedia information from the first terminal device,
the step of sending includes sending the share request and the address of the first terminal device to the second terminal device, and
when an acknowledgement, indicating that the multimedia information is transmittable, is received from the second terminal device in response to the share request, the step of sending includes sending a request to receive the multimedia information to the first terminal device.

17. The method of claim 16, wherein the second terminal device has a transmitting-end database on which the multimedia information, including at least one title, and title information, representing the properties of the at least one title, are stored, and
wherein the step of receiving includes receiving the title information, stored in the transmitting-end database, from the second terminal device, and
wherein the step of processing includes making a title list, including predetermined titles, based on the title information and the identifier of the first terminal device, and
wherein when in the step of sending, the title list is sent to the first terminal device after that,
the step of receiving includes receiving a request to share the multimedia information, selected by reference to the title list, from the first terminal device.

18. The method of claim 17, wherein the step of processing includes making a tilt list including titles that are playable by the first terminal device.

19. The method of claim 11, wherein the address includes an IP address and a port number.

20. The method of claim 13, further comprising the step of searching the title information that is stored in the transmitting-end database,
wherein the step of receiving includes receiving the title information based on a result of the step of searching.
